(19) United States
(12) Patent Application Publication
(10) Pub. No.: US 2013/0216108 A1
(43) Pub. Date: Aug. 22, 2013

(54) ELECTRONIC DEVICE AND METHOD FOR USER IDENTIFICATION

(71) Applicant: PANTECH CO., LTD., Seoul (KR)

(72) Inventors: Sun Mi HWANG, Seoul (KR); Hun Hee Kang, Seoul (KR)

(73) Assignee: PANTECH CO., LTD., Seoul (KR)

(21) Appl. No.: 13/685,073

(22) Filed: Nov. 26, 2012

(30) Foreign Application Priority Data
Feb. 22, 2012 (KR) 10-2012-0018110

(51) Int. Cl. G06K 9/00

(52) U.S. Cl. CPC G06K 9/00221
USPC 382/118

(57) ABSTRACT

An electronic terminal and method for user authentication determine if a user may access the electronic device according to a comparison of a captured user image with a reference image. If authentication fails using the captured user image, a second user authentication method may be displayed. If authentication is successful via the second user authentication method, the reference image may be updated according to the captured user image.

### CROSS-REFERENCE TO RELATED APPLICATION

This application claims priority from and the benefit of Korean Patent Application No. 10-2012-0018110, filed on Feb. 22, 2012, which is incorporated by reference for all purposes as if fully set forth herein.

### BACKGROUND

1. Field

The following description relates to an electronic device and method for user authentication and, more particularly, to an electronic device and method for user authentication using a user image.

2. Discussion of the Background

A mobile device implemented in the form of a multimedia device may perform complicated functions using hardware or software. The functions may include message transmission/reception, voice call, and pay services, such as, video call, web services, and application download. There is a need to prevent various pay services from being used without authorization by other people. As a mobile device has been increasingly used in daily life, a need to protect privacy of individuals, i.e., a need to restrict access of other people to information included in mobile devices has increased. A security function has become important in other electronic devices as well.

For a security operation of an electronic device, a password entered using a keypad has been variously implemented. As touch panels have developed, a hardware keypad or a software keypad may be implemented. For example, a software keypad has been provided in which the positions of the buttons of the keypad are changed such that, if a user enters a password, a third person may not be able to guess the keys entered to determine the password of the user thereby providing security.

With the development of touch panels, a security operation using a touch gesture pattern may be implemented. In a smart phone and a smart pad using an Android OS provided by Google® Inc., a user may use a stored touch gesture on a touch screen to be used as a user identifier.

A security operation using human body information may be implemented for security. An iris recognition system using an iris and an automatic recognition method thereof has been developed. A mobile communication terminal of a fingerprint recognition system using a fingerprint has been developed. Authentication of a mobile terminal through image recognition has been developed. Image recognition may be used in a security field.

In authentication of an electronic device through image recognition, recognition error may be generated because various factors such as a capturing angle, intensity of illumination, presence/absence of glasses, presence/absence of a hat or presence/absence of hair dyeing may be changed.

### SUMMARY

Exemplary embodiments of the present invention provide an electronic device and method for user authentication.

Additional features of the invention will be set forth in the description which follows, and in part will be apparent from the description, or may be learned by practice of the invention.

An exemplary embodiment of the present invention discloses an electronic device, including: a camera unit to capture an image; a first unlock unit to determine whether the image matches a reference image and to provide access to the electronic device according to the determination; and a second unlock unit to provide access to the electronic device if the first unlock unit fails to provide access to the electronic device.

An exemplary embodiment of the present invention also discloses a method for user authentication in an electronic device, including: capturing a user image; determining if the user image matches a reference image and providing access to the electronic device if the user image matches the reference image; if the user image does not match a reference image, displaying a user interface to receive user authentication information; and if the user authentication information matches reference user authentication information, providing access to the electronic device.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of an electronic device according to an exemplary embodiment of the present disclosure.

FIG. 2 is a flowchart of a user authentication method of an electronic device according to an exemplary embodiment of the present disclosure.

FIG. 3 is a flowchart of a user authentication method of an electronic device according to an exemplary embodiment of the present disclosure.

FIG. 4 is a flowchart of a user authentication method of an electronic device according to an exemplary embodiment of the present disclosure.

FIG. 5 is a flowchart of a user authentication method of an electronic device according to an exemplary embodiment of the present disclosure.

FIG. 6 is a flowchart illustrating a user authentication method of an electronic device according to an exemplary embodiment of the present disclosure.

FIG. 7 is a flowchart of a user authentication method of an electronic device according to an exemplary embodiment of the present disclosure.

FIG. 8 is a flowchart of a user authentication method of an electronic device according to an exemplary embodiment of the present disclosure.

### DETAILED DESCRIPTION OF THE ILLUSTRATED EMBODIMENTS

Exemplary embodiments are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. Although features may be shown as separate, such features may be implemented together or individually. Further, although features may be illustrated in association with an exemplary embodiment, features for one or more exemplary embodiments may be combinable with features from one or more other exemplary embodiments.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

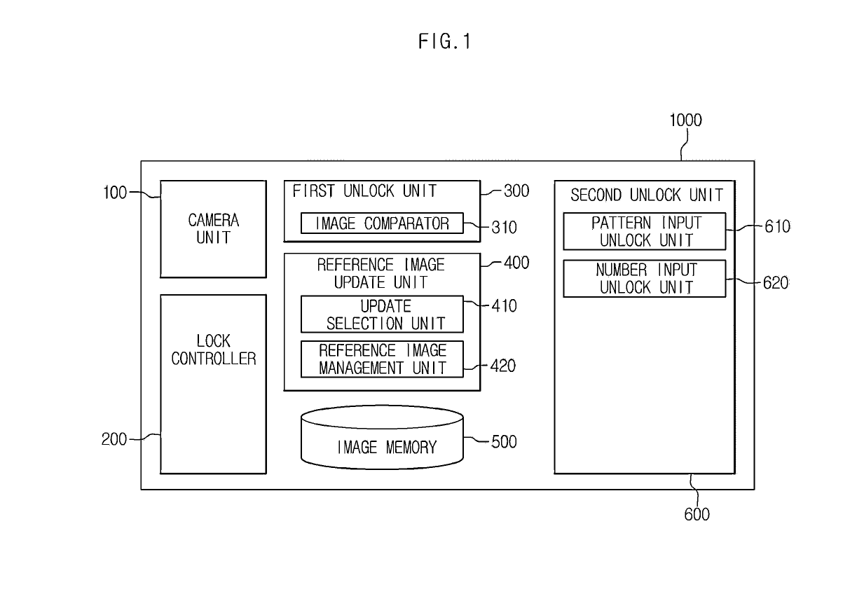

FIG. 1 is a block diagram of an electronic device according to an exemplary embodiment of the present disclosure. An electronic device 1000 includes a camera unit 100, a lock controller 200, a first unlock unit 300, a reference image update unit 400, an image memory 500 and a second unlock unit 600.

A lock screen may be provided if a user sets a lock operation of an electronic device, and an unlock input may be received on the lock screen. The state in which the lock screen is provided may be referred to as a lock state. An unlock state may be referred to as an active state and may be entered into after a valid unlock input is received. A lock operation may be provided to prevent other people from utilizing a pay service and to protect privacy information included in an electronic device. A representative example of a lock state includes, for example, a hold screen. The hold screen may be a screen which is displayed if a user turns an electronic device on in a sleep mode and may be displayed before a standby screen. The lock screen may be used as a security screen for hiding important information of a user, such as a photo, an address book, a message, a phone record, etc. A method for switching a lock screen to an active state may include various methods, such as user face recognition, password input, gesture input, etc. If face recognition fails because the appearance of an owner of an electronic device differs from a previous image, e.g., if an owner of an electronic device unusually wears glasses, a current state of the owner is automatically updated to a database, thereby improving a face recognition rate.

A face recognition method will be described. Face recognition may be divided into two operations: an operation of extracting a face region and an operation of identifying a face.

(1) Operation of Extracting Face Region

The operation of extracting a face region may be a preprocessing operation of face recognition. In order to distinguish between a face and a background, information, such as brightness, motion, color, or eye position estimation, may be used. It may be difficult to accurately extract a face using one piece of information. For example, in the case where a face region is extracted using brightness information, if a difference between the brightness values of the face and the background is large, the face region may be easily extracted. If the face and the background have similar brightness values or the background has various colors, a part of the background may be erroneously recognized as a face. In a method for using color information, pixels having an input skin color may be extracted. If a skin color is similar to a background color, a face region may not be accurately extracted. Face recognition may also be influenced by external factors such as ambient lighting or presence/absence of makeup. In order to extract a face region, two or more pieces of information may be used.

(2) Face Identification Operation

A method for identifying a face using a distance between and shapes of parts of a face, such as eyes, a nose and a mouse, has difficulty in accurately extracting the main parts of the face. If glasses, a cap or hair hide eyes, a nose and a mouse, accurate identification may be difficult. A method for comparing pixel values and conducting identification may be used to identify a face if a new face image is received in a state of holding a plurality of face images. This method for comparing pixel values may compare images one by one and thus a calculation time and memory may be increased because comparisons of images in which face expression, angle, and lighting are changed may be necessary. A principal component analysis (PCA) method may be used. The PCA method is a method of taking only large features of a face while ignoring small features, converting the features into a coordinate system, and comparing the face with another face image. If the PCA method is used, the amount of data may be reduced to increase efficiency. However, in the PCA method, a change in lighting or face expression may not be recognized.

The electronic device 1000 may be implemented in various forms and may include various features. The electronic device 1000 may include devices to execute a specific application and the type thereof is not limited. An application, that is, any program, may be executed using the electronic device 1000, and a camera operation, a memory operation and a control operation of the electronic device 1000 may be used. For example, the electronic device 1000 may include a computer, such as, a personal computer, a laptop, a netbook, a tablet computer, etc., a server, a handheld wireless terminal, such as, a Personal Communication System (PCS) terminal, a Global System for Mobile communications (GSM) terminal, a Personal Digital Cellular (PDC) terminal, a Personal Handyphone System (PHS), a Personal Digital Assistant (PDA) or an International Mobile Telecommunication (IMT)-2000 terminal. The electronic device 1000 may be a smart phone, small smart pad, etc., and may including a display, a touch sensor, a motion sensor, a vibration unit, a speaker unit, a communication module, etc. The electronic device 1000 may include, for example, a processing system which may include a processor, an operating system (OS), and an application program interface (API) and may provide communication between one or more software applications and the OS. The electronic device 1000 may be a door lock device to manage entry to and exit from a building, for example, an office, and to control a door or a security device to search for a suspect and to monitor a crime-ridden district. The processing system of the electronic device 1000 may be configured to execute a variety of software applications. The electronic device 1000 may communicate with an object and may include at least one of communication hardware and communication software. The communication method may be any communication method performed between objects, for example, a wired/wireless communication, 3G, 4G, etc. Transmittable information and/or receivable information may be transmitted to an external object or may be received from an internal component. Transmittable information and/or receivable information may include may include information about various sensors included in the mobile device 1000, voice feedback information and vibration feedback information. The communication method may include at least one of a Local Area Network (LAN), Metropolitan Area Network (MAN), Global System for Mobile Network (GSM), Enhanced Data GSM Environment (EDGE), High Speed Downlink Packet Access (HSDPA), Wideband Code Division Multiple Access (W-CDMA), Code Division Multiple Access (CDMA), Time Division Multiple Access (TDMA), Bluetooth®, Zigbee®, Wi-Fi, Voice over Internet Protocol (VoIP), LTE Advanced, IEEE802.16m, WirelessMAN-Advanced, Evolved High-Speed Packet Access (HSPA+), 3GPP Long Term Evolution (LTE), Mobile WiMAX (IEEE 802.16e), Ultra Mobile Broadband (UMB) (formerly Evolution-Data Optimized (EV-DO) Rev. C), Fast Low-latency Access with Seamless Handoff Orthogonal Frequency Division Multiplexing (Flash-OFDM), High Capacity Spatial Division Multiple Access (iBurst®) and Mobile Broadband Wireless Access (MBWA) (IEEE 802.20) systems, High Performance Radio Metropolitan Area Network (HIPERMAN), Beam-Division Multiple Access (BDMA), World Interoperability for Microwave Access (Wi-MAX) and ultrasonic communication, etc., but is not limited thereto.

The camera unit 100 may be configured to capture an image of a user. The camera unit 100 may be any camera or video image recorder device. The camera unit 100 may include at least one camera. The user image captured by the camera unit 100 may be arbitrary. According to aspects of the present invention, a user image is not limited to a user's face, and any other image of a user may be used, for example, the lines on a palm of a hand, the shape of a foot, etc. may be used. If the intensity of illumination, the position of the face, face expression, etc. changes, the camera unit 100 may capture a plurality of user images. The user image captured by the camera unit 100 may be used as comparison data for user authorization. The user image captured by the camera unit 100 may be stored in the image memory 500.

The first unlock unit 300 may be configured to switch the electronic device 1000 from a lock state to an active state if a user image matches a reference image. The first unlock unit 300 may include an image comparator 310. The user image may include an image captured by the camera unit 100. The reference user image may be stored in the image memory 500. A first reference image may be registered upon an initial lock registration of the electronic device 1000 and may include a plurality of images.

The image comparator 310 may be configured to compare the user image with the reference image to determine image identity. The image comparator 310 may use a well-known image comparison algorithm. Image identity may refer to pixel identity or substantial identity in a reference criterion. In the image identification, i.e., the image comparison, of the image comparator 310, a comparison time may be stored and a user image may be stored if the comparison time exceeds a reference minimum comparison time. The stored user image may be used for subsequent face recognition.

A second unlock unit 600 may be configured to provide an interface to switch the electronic device 1000 from the lock state to the active state according to a user input. If a user of the electronic device 1000 fails to unlock the electronic device 1000 due to incomplete authentication of the first unlock unit 300, the user may not use the electronic device 1000. The user may not use all the operations of the electronic device 1000 according to the first unlock unit. The first unlock unit may include a highly developed technique to complete authentication. The second unlock unit 600 may be configured to enable the user of the electronic device 1000 to use the electronic device 1000 even if the authentication operation of the first unlock unit 300 fails. Since the user of the electronic device 1000 may know another security authentication method (e.g., a security password), although a first unlock operation fails, the user may be authenticated as a legal user of the electronic device 1000 by performing a second unlock operation. In order to implement an authentication operation, the second unlock unit 600 may include a pattern input unlock unit 610 and a number input unlock unit 620. If the user of the electronic device 1000 selects to unlock the electronic device 1000 using the first unlock unit, i.e., the user image, the second unlock unit 600 provides an interface if the user image does not match the reference image in the first unlock unit 300. If user authentication fails by the first unlock unit 300, a number of opportunities to perform user authentication using the first unlock unit 300 may be provided. The user image may be captured a number of times (e.g., three times) using the first unlock unit 300. If the number of authentication operations fails using the first unlock unit, an interface may be provided. If user authentication fails using the first unlock unit 300, an interface of the second unlock unit 600 may be provided. The interface of the second unlock unit 600 may use an arbitrary unlock operation without using the user image. For example, the pattern input unlock unit 610 may detect a continuous pattern drawn on a keypad-type touch screen using a finger and switch the electronic device 1000 from the lock state to the active state if the detected pattern matches a stored reference pattern. This method may be implemented in the electronic device 1000 using a touch screen and may be a unlock module supported by an Android OS of a smart phone.

The number input unlock unit 620 may be configured to parse an input into a keypad of a keypad-type touch screen or a hardware keypad to enter a password and switch the electronic device 1000 from the lock state to the active state if the entered password matches a stored password.

The second unlock unit 600 may include a voice recognition unit (not shown) to perform user authentication via voice recognition.

The lock controller 200 may be configured to display the interface of the second unlock unit 600 if the user image does not match the reference image. The first unlock unit 300 may compare the user image captured by the camera unit 100 with the reference image stored in the image memory 500, and the interface provided by the second unlock unit 600 may be displayed by the lock controller 200 if the user image captured by the camera unit 100 does not match the reference image. The first unlock unit 300 may use the user image as an identity criterion unlike other unlock units. Accordingly, if the second unlock unit 600 may be used upon failure of the first unlock unit 300, the electronic device 1000 may be enabled to be used. The lock controller 200 may use one second unlock unit 600 or a plurality of second unlock units 600. For example, a pattern input unlock interface may be provided by a pattern input unlock unit 610 if the user image does not match the reference image and a user may unlock the electronic device 1000 by inputting a pattern in the pattern input unlock interface, and a number input unlock interface may be provided by the number input unlock unit 620 if the user image does not match the reference image and a user may unlock the electronic device 1000 by inputting numbers into the number input unlock interface.

The reference image update unit 400 may be configured to store the user image as a reference image if the electronic device 1000 is switched from the lock state to the active state using the interface of the second unlock unit 600. The reference image update unit 400 may include an update selection unit 410 and a reference image management unit 420. If the electronic device 1000 is switched from the lock state to the active state using the interface of the second unlock unit 600 and an authentication failure results occurs in the first unlock unit 300, the user image compared by the first unlock unit 300 may be stored in the image memory 500 as the reference image. For example, if authentication is attempted in a state in which the user wears glasses unlike the reference image, it may be determined that the user image is different from the reference image due to the glasses. If the lock state is switched to the active state using a subsequent unlock method such as a pattern input unlock method, the user image of the state in which the user wears the glasses may be stored as the reference image in the image memory 500. A plurality of reference images may be stored in the image memory 500. A previous reference image may be deleted and a new reference image may be stored. In other words, an overwriting method may be used to overwrite a reference image stored in the image memory 500. If the electronic device 1000 is switched from the lock state to the active state using the interface of the second unlock unit 600 provided if the authentication fails in the first unlock unit 300, the user image compared by the first unlock unit 300 may be automatically stored in the image memory 500 as the reference image, regardless of a user input or intention. This may be referred to as automatic update\.

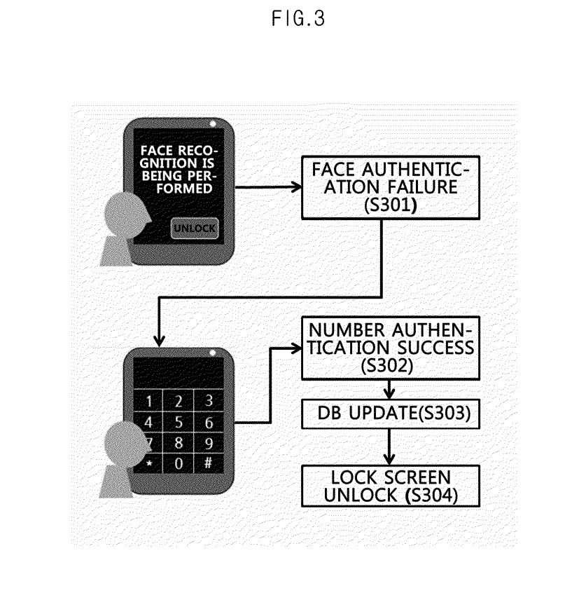

FIG. 3 is a flowchart of a user authentication method of an electronic device according to an exemplary embodiment of the present invention. Although FIG. 3 will described with reference to FIG. 1, aspects of the exemplary embodiments are not limited thereto.

Referring to FIG. 3, face authentication is performed using the first unlock unit 300. If face authentication is successful, access is provided to the electronic device 1000. If face authentication using the first unlock unit 300 fails, as in operation S301, an authentication method using the number input unlock unit 620 begins. Although a keypad is shown in FIG. 3, aspects need not be limited thereto such that another form of lock, for example, a representation of a combination lock, may be displayed. If authentication using the keypad is not successful, the electronic device 1000 remains in a locked state. In operation 302, number authentication is successful. In operation S303, the reference image of a database, i.e., the image memory 500, may be updated without user selection or automatically. In operation S304, the lock screen is unlocked. Although depicted as being performed serially, those skilled in the art will appreciate that at least a portion of the operations of method FIG. 3 may be performed contemporaneously, or in a different order than presented in FIG. 3. For example, operation S303 and operation S304 may not be sequentially performed. For example, after the lock screen is unlocked in operation S304, the database may be updated in operation S303. Automatic update may be set initially or at an arbitrary time. Automatic update may be selected to maintain a new database. If face authentication using the first unlock unit 300 fails in operation S301, a reference number of authentication opportunities may be provided in the first unlock unit 300. In other words, the user image may be captured using the first unlock unit 300 more than once. If face authentication using the first unlock unit 300 is successful as a result of the additionally provided authentication opportunities of the first unlock unit 300, i.e., if the recaptured image matches the reference image and authentication is successful, the user image for which authentication failed, may be stored as the reference image of the image memory 500 in operation S303 and the lock screen may be unlocked in operation S304.

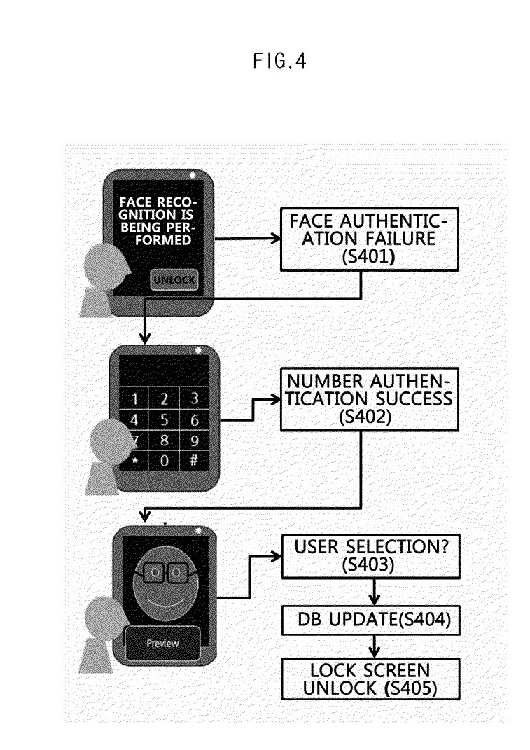

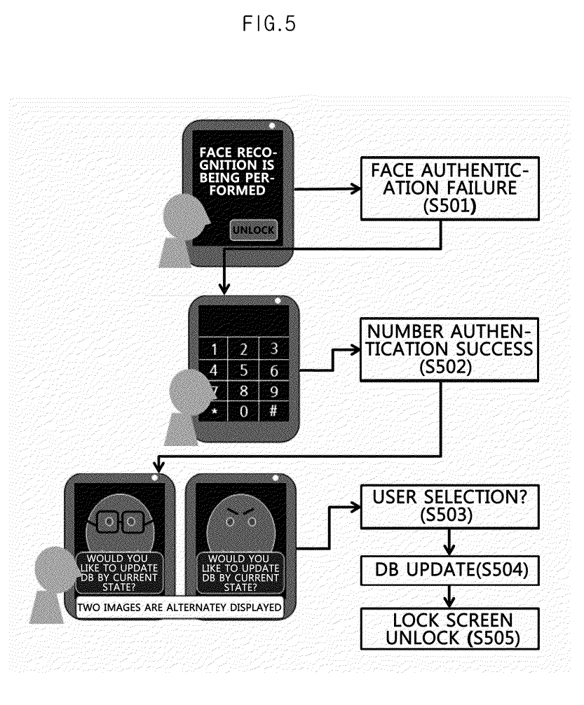

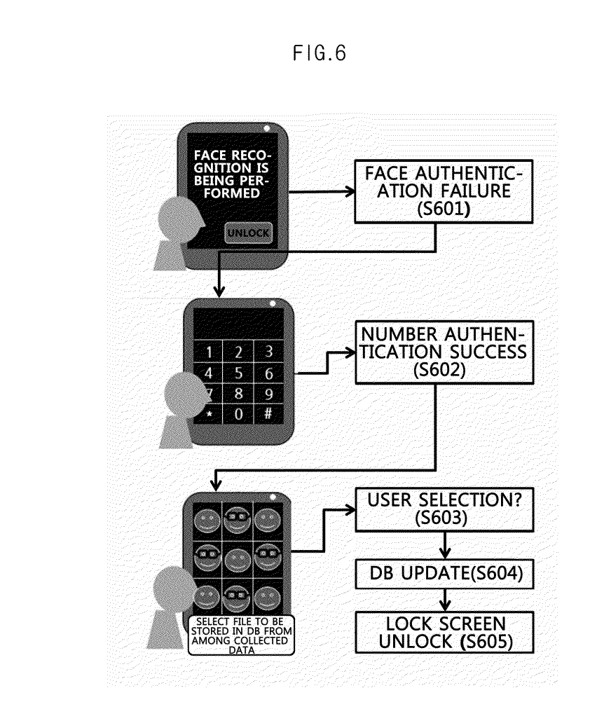

The update selection unit 410 may be configured to display the user image or the reference image and determine whether to store the user image in image memory 500 as the reference image according to a user selection input. This will be described in detail with reference to FIG. 4, FIG. 5, and FIG. 6.

FIG. 4 is a flowchart of a user authentication method of an electronic device according to an exemplary embodiment of the present disclosure. Although FIG. 3 will described with reference to FIG. 1, aspects of the exemplary embodiments are not limited thereto. Referring to FIG. 4, face authentication is performed using the first unlock unit 300. If face authentication is successful, access is provided to the electronic device 1000. If face authentication using the first unlock unit 300 fails, as in operation S401, an authentication method using the number input unlock unit 620 begins. Although a keypad is shown in FIG. 3, aspects need not be limited thereto such that another form of lock, for example, a representation of a combination lock, may be displayed. If authentication using the keypad is not successful, the electronic device 1000 remains in a locked state. If authentication is successful using the keypad, in operation S402, the update selection unit 410 may display a preview image. The update selection unit 410 displays the user image captured by the camera unit 100 to the user. In operation S403, the user may determine whether to store the user image in the image memory 500. For example, if an image includes problems, such as, shaking, red-eye effect, backlight effect, pose problems, etc., the user may select to not store the user image as the reference image. If the user selects not to store the user image as the reference image, the operation of updating the reference image is omitted. If the user selects to store the user image as the reference image, in operation S404, the reference image of the image memory 500 is updated. In operation S405, the lock screen is unlocked. Although depicted as being performed serially, those skilled in the art will appreciate that at least a portion of the operations of method FIG. 4 may be performed contemporaneously, or in a different order than presented in FIG. 4. For example, after the lock screen is unlocked in operation S405, the database may be updated in operation S404.

FIG. 5 is a flowchart of a user authentication method of an electronic device according to an exemplary embodiment of the present disclosure. Although FIG. 5 will described with reference to FIG. 1, aspects of the exemplary embodiments are not limited thereto. Although depicted as being performed serially, those skilled in the art will appreciate that at least a portion of the operations of method FIG. 5 may be performed contemporaneously, or in a different order than presented in FIG. 5. Referring to FIG. 5, face authentication is performed using the first unlock unit 300. If face authentication is successful, access is provided to the electronic device 1000. In operation S501, face authentication using the first unlock unit 300 fails. An authentication method using the number input unlock unit 620 begins. Although a keypad is shown in FIG. 3, aspects need not be limited thereto such that another form of lock, for example, a representation of a combination lock, may be displayed. If authentication using the keypad is not successful, the electronic device 1000 remains in a locked state. In operation S502, number authentication is successful. The update selection unit 410 may display both the user image and the reference image. The user image and the reference image may be alternately displayed. The user image and the reference image may be simultaneously displayed in a state of horizontally or vertically dividing the screen. The method of displaying the user image and the reference image is not limited. A screen for comparing the stored reference image with the currently captured user image may be displayed. In operation S503, the user may determine whether to store the user image in the image memory 500. If the user determines not to store an image as the reference image, access to the electronic device 1000 is provided by proceeding to operation 505. If the user selects to store the user image as the reference image, in operation S504, the reference image of the image memory 500 is updated. In operation S505, the lock screen is unlocked.

FIG. 6 is a flowchart illustrating a user authentication method of an electronic device according to an exemplary embodiment of the present disclosure. Although FIG. 6 will described with reference to FIG. 1, aspects of the exemplary embodiments are not limited thereto. Although depicted as being performed serially, those skilled in the art will appreciate that at least a portion of the operations of method FIG. 6 may be performed contemporaneously, or in a different order than presented in FIG. 6. Referring to FIG. 6, face authentication is performed using the first unlock unit 300. If face authentication is successful, access is provided to the electronic device 1000. In operation S601, face authentication using the first unlock unit 300 fails. An authentication method using the number input unlock unit 620 begins. Although a keypad is shown in FIG. 3, aspects need not be limited thereto such that another form of lock, for example, a representation of a combination lock, may be displayed. If number authentication using the keypad is not successful, the electronic device 1000 remains in a locked state. In operation S602, number authentication is successful. In FIG. 6, if a user image is captured on a lock screen, the camera unit 100 may capture a plurality of user images and may display the plurality of user images. The plurality of user images may depict a different intensity of illumination, the position of the face, the face expression, etc. of the user. A multi-image capturing operation may be automatically set or may be set by a user. In operation S603, the user may determine whether to store a displayed user image in the image memory 500. The user may select to not store an undesired image as the reference image. If the user selects to store one of the displayed user images as the reference image, in operation S604, the reference image of the image memory 500 is updated. In operation S605, the lock screen is unlocked and access to the electronic device 1000 is provided.

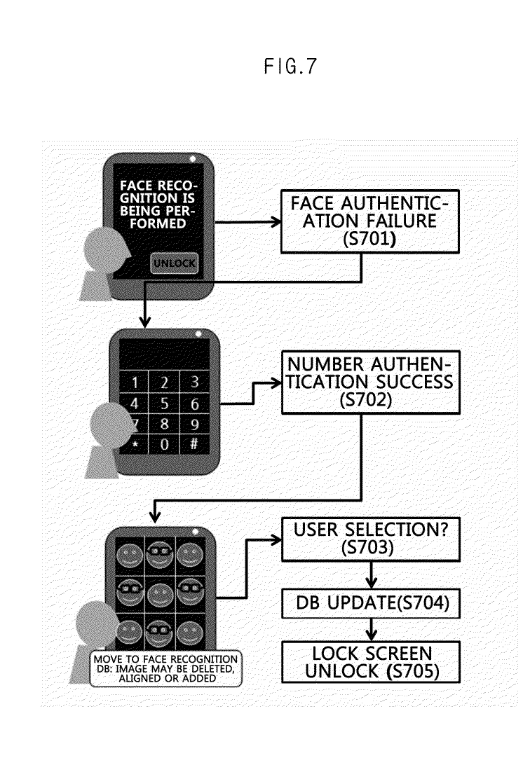

The reference image management unit 420 may be configured to manage a reference image, for example, to delete, align, or add a reference image. The stored reference image may be changed using the electronic device 1000 and, for example, an undesired image may be deleted. A reference image may be added through different image capturing operation. If the user selects to update the reference image using the update selection unit 410, the reference image management unit 420 may operate. This will be described with reference to FIG. 7.

FIG. 7 is a flowchart of a user authentication method of an electronic device according to an exemplary embodiment of the present disclosure. Although FIG. 7 will described with reference to FIG. 1, aspects of the exemplary embodiments are not limited thereto. Although depicted as being performed serially, those skilled in the art will appreciate that at least a portion of the operations of method FIG. 7 may be performed contemporaneously, or in a different order than presented in FIG. 7. Referring to FIG. 7, face authentication is performed using the first unlock unit 300. If face authentication is successful, access is provided to the electronic device 1000. In operation S701, face authentication using the first unlock unit 300 fails. An authentication method using the number input unlock unit 620 begins. Although a keypad is shown in FIG. 3, aspects need not be limited thereto such that another form of lock, for example, a representation of a combination lock, may be displayed. If number authentication using the keypad is not successful, the electronic device 1000 remains in a locked state. In operation S702, number authentication is successful. The electronic device 1000 displays a plurality of reference images. FIG. 7 is similar to FIG. 6 except that previously stored reference images are displayed in FIG. 7. Upon face recognition failure, a reference image management interface may be provided through the image management unit 420 such that the user may access the image memory 500 to change the reference image if requiring update. In operation S703, the user may determine whether to store the user image in the image memory 500. If the user selects to store the user image as the reference image, in operation S704, the reference image of the image memory 500 is updated. In operation S705, the lock screen is unlocked.

The image memory 500 may be configured to store the reference image and to store the user image. The image memory 500 may temporarily store the user image. The image memory 500 may be a database, a storage medium, object, etc. A plurality of reference images or user images may be stored in the image memory 500. Objects stored in the image memory 500 may be deleted or aligned or a new object may be added to the image memory 500.

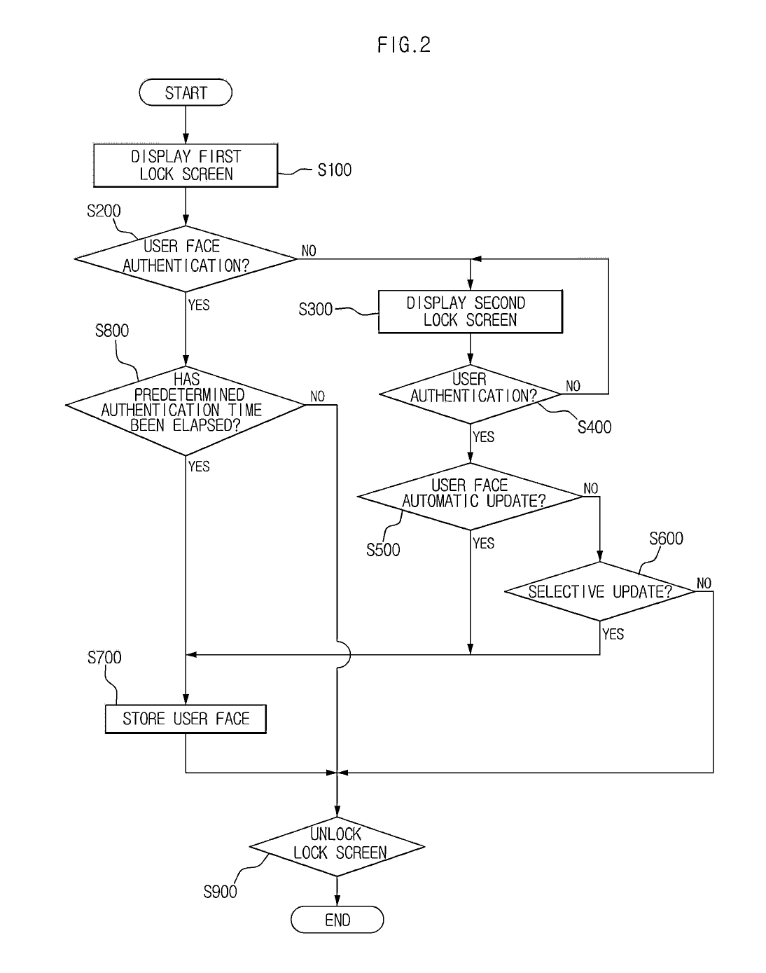

FIG. 2 is a flowchart of a user authentication method of an electronic device according to an exemplary embodiment of the present disclosure. Although FIG. 2 will described with reference to FIG. 1, aspects of the exemplary embodiments are not limited thereto. Although depicted as being performed serially, those skilled in the art will appreciate that at least a portion of the operations of method FIG. 2 may be performed contemporaneously, or in a different order than presented in FIG. 2. In operation S100, a first lock screen provided by the electronic device 1000 is displayed. In operation S200, it is determined if a user image captured by a camera matches a stored reference image. If the user image captured by the camera matches the reference image, the first lock screen is unlocked so that the electronic device 1000 is operated in an active state. If the user image does not match the reference image, a second lock screen is displayed in operation S300. The second lock screen may be a pattern input screen, a number input screen and a voice input screen, etc. In operation S400, it is determined if user authentication is successful in the second lock screen. If user authentication is successful on the second lock screen, the reference image may be updated by storing the captured user image. In operation S500, it is determined if automatic update is set or if selective update is inactivated (not shown). If automatic update is set, in operation S700, the user image is automatically stored in the image memory 500. In operation S900, the lock screen is unlocked. The operation S700 and the operation S900 may not be sequentially performed and the order thereof may be changed. If automatic update is not set in operation S500, it may be determined whether selective update is set by user selection input. If selective update is not set by user input, in operation S900 the lock screen is unlocked without performing a special operation. If selective update is set by user input, the selected user image may be stored as the reference image in operation S700 and the lock screen is unlocked in operation S900.

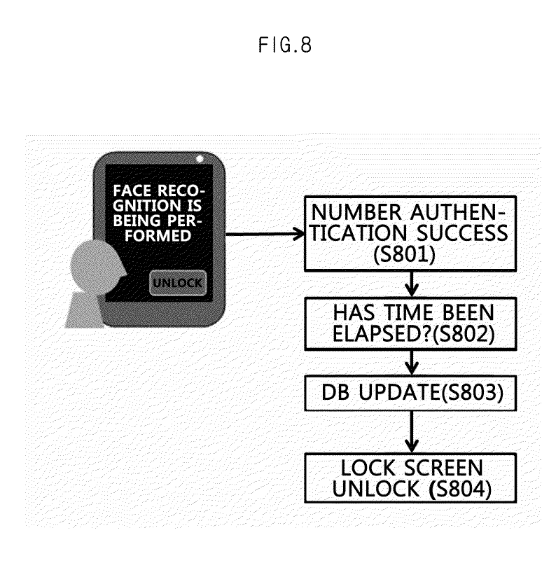

If the user image matches the stored reference image on the first lock screen in operation S200, the lock screen is unlocked in operation S900. However, in operation S800 it is determined if a time to compare the user image with the stored reference image on the first lock screen exceeds a reference time. If the time to compare the user image with the stored reference image exceeds the reference time, the user image is stored as the reference image in operation S700. This process is shown in FIG. 8.

FIG. 8 is a flowchart of a user authentication method of an electronic device according to an exemplary embodiment of the present disclosure. Although FIG. 8 will described with reference to FIG. 1, aspects of the exemplary embodiments are not limited thereto. Although depicted as being performed serially, those skilled in the art will appreciate that at least a portion of the operations of method FIG. 8 may be performed contemporaneously, or in a different order than presented in FIG. 8. Referring to FIG. 8, face authentication using the first unlock unit 300 is performed. If face authentication is successful, access is provided to the electronic device 1000. In operation S801, face authentication fails. In operation S802, it is determined if a reference time has elapsed. Although face recognition is successful on the lock screen, a recognition rate may be decreased due to an ambient environment factors, such as an intensity of illumination, and it may take time to recognize a face. If face recognition is successful to unlock the lock screen after a reference time, the operation may not be immediately performed, but an opportunity to update the database using the captured user image may be provided to a user. In operation S803, the user may determine whether to store the user image in the image memory 500. Therefore, it may be possible to configure a database to improve a recognition rate. In operation S804, the lock screen may be unlocked.

According to exemplary embodiments of the present disclosure, it may be possible to reduce face recognition error due to various face states of a user and to efficiently use a face recognition operation in authentication of an electronic device.

According to exemplary embodiments of the present disclosure, it may be possible to improve a recognition operation even if a face state such as intensity of illumination or an angle is changed and to maximize a camera operation.

According to exemplary embodiments of the present disclosure, it may be possible to automatically update a face recognition database if a user does not periodically or aperiodically update the face recognition database and to increase a face recognition rate.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An electronic device, comprising:
a camera unit to capture an image;
a first unlock unit to determine whether the image matches a reference image and to provide access to the electronic device according to the determination; and
a second unlock unit to provide access to the electronic device if the first unlock unit fails to provide access to the electronic device.

2. The device of claim 1, further comprising:
a reference image update unit to update the reference image if the first unlock unit determines that the image does not match the reference image.

3. The device of claim 1, wherein the second unlock unit determines if an input matches user authentication information and according to the determination provides access to the electronic device.

4. The device of claim 3, wherein the user authentication information is at least one of a pattern, a number, and a password.

5. The device of claim 1, wherein the second unlock unit determines if an input matches a pattern and according to the determination provides access to the electronic device.

6. The device of claim 1, further comprising:
a lock controller to display a user interface of the second unlock unit and to receive input on the user interface.

7. The device of claim 1, the first unlock unit comprises an image comparator to compare the reference image to the image.

8. The device of claim 2, wherein the reference image update unit comprises an update selection unit to display the reference image and the image and to store the image as the reference image.

9. The device of claim 8, wherein the reference image update unit further comprises a reference image management unit to manage a reference image.

10. The device of claim 1, wherein the camera unit captures a plurality of images and if the second unlock unit provides access to the electronic device, the second unlock unit displays the plurality of images and according to a selection of at least one of the plurality of images updates the reference image.

11. The device of claim 1, wherein if the second unlock unit provides access to the electronic device, the second unlock unit displays a plurality of reference images and according to a selection of at least one of the plurality of images updates the reference image.

12. A method for user authentication in an electronic device, comprising:
capturing a user image;
determining if the user image matches a reference image and providing access to the electronic device if the user image matches the reference image;
if the user image does not match a reference image, displaying a user interface to receive user authentication information; and
if the user authentication information matches reference user authentication information, providing access to the electronic device.

13. The method of claim 12, further comprising
updating the reference image according the user image if the user image does not match the reference image.

14. The method of claim 12, wherein the user authentication information is at least one of a pattern, a number, and a password.

15. The method of claim 12, further comprising:
displaying a user interface to request to update of the reference image if the user image does not match the reference image.

16. The method of claim 12, further comprising:
determining if a reference time has elapsed after determining that the user image matches a reference image and before providing access to the electronic device; and
if the reference time has elapsed, storing the user image as the reference image.

17. The method of claim 12, further comprising:
capturing a plurality of user images;
displaying the plurality of images if the user images do not match the reference image; and
updating the reference image according to a selection of at least one of the plurality of images.

18. The method of claim 17, wherein the plurality of images are displayed together on a screen.

19. The method of claim 12, wherein if the user image does not match the reference image:
displaying a plurality of reference images; and
updating the reference image according to a selection of at least one of the plurality of reference images.

20. The method of claim 19, wherein the plurality of images are displayed together on a screen.
